(19) United States
(12) Patent Application Publication
(10) Pub. No.: US 2020/0151858 A1
(43) Pub. Date: May 14, 2020

(54) IMAGE CONTRAST ENHANCEMENT METHOD AND DEVICE, AND STORAGE MEDIUM

(71) Applicant: SZ DJI TECHNOLOGY CO., LTD., Shenzhen (CN)

(72) Inventors: Jianrui CAI, Shenzhen (CN); Zisheng CAO, Shenzhen (CN); Pan HU, Shenzhen (CN)

(21) Appl. No.: 16/742,145

(22) Filed: Jan. 14, 2020

Related U.S. Application Data
(63) Continuation of application No. PCT/CN2017/094650, filed on Jul. 27, 2017.

(51) Int. Cl. G06T 5/00; G06T 5/50; G06N 3/04; G06N 3/08

(52) U.S. Cl. CPC G06T 5/007; G06T 5/50; G06N 3/04; G06T 2207/20084; G06T 2207/10144; G06T 2207/20221; G06T 2207/20081; G06N 3/084

(57) ABSTRACT

An image contrast enhancement method includes calling a neural network trained using a set of image pairs each including a first image and a second image for a same scene, inputting a third image to the neural network, and obtaining a fourth image outputted by mapping the third image via the neural network. An image contrast of the first image is lower than an image contrast of the second image, and an image contrast of the fourth image is higher than an image contrast of the third image.

### CROSS-REFERENCE TO RELATED APPLICATION

This application is a continuation of International Application No. PCT/CN2017/094650, filed on Jul. 27, 2017, the entire content of which is incorporated herein by reference.

### TECHNICAL FIELD

The present disclosure relates to the field of image processing, and in particular to an image contrast enhancement method, device, and storage.

### BACKGROUND

Because an exposure range of an image sensor, such as a charge coupled device (CCD), is generally lower than a dynamic range of a natural scene, an overexposure or underexposure situation is likely to occur when a digital photographing device is shooting in an outdoor scene or a night scene. Therefore, an image contrast needs to be enhanced to improve detailed information in the image, thereby providing a more reliable input image for computer visual recognition.

In conventional technologies, an enhancement algorithm applying to a single image is used to enhance the image contrast. For example, an image contrast enhancement algorithm based on the Retinex theory. The principle of the algorithm is to decompose the image into a light intensity portion having low frequency and a detail portion having high frequency, and enhance the image contrast of the original image by optimizing the light intensity portion having low-frequency. However, the algorithm described above optimizes the light intensity portion based on a predetermined condition. Because the real image is complicated, and hence the predetermined condition cannot well reflect the color of the real-world. As such, the image with enhanced contrast appears an unrealistic effect, resulting in a low image quality.

### SUMMARY

In accordance with the disclosure, there is provided an image contrast enhancement method including calling a neural network trained using a set of image pairs each including a first image and a second image for a same scene, inputting a third image to the neural network, and obtaining a fourth image outputted by mapping the third image via the neural network. An image contrast of the first image is lower than an image contrast of the second image, and an image contrast of the fourth image is higher than an image contrast of the third image.

Also in accordance with the disclosure, there is provided an image contrast enhancement apparatus including a processor and a memory coupled to the processor and storing computer readable instructions that, when executed by the processor, cause the processor to call a neural network trained using a set of image pairs each including a first image and a second image for a same scene, input a third image to the neural network, and obtain a fourth image outputted by mapping the third image via the neural network. An image contrast of the first image is lower than an image contrast of the second image, and an image contrast of the fourth image is higher than an image contrast of the third image.

Also in accordance with the disclosure, there is provided a model training method including generating a set of image pairs using a multi-exposure image fusion algorithm, and training a neural network using the set of image pairs. Each image pair of the set of image pairs includes a first image and a second image for a same scene. An image contrast of the first image is lower than an image contrast of the second image.

### BRIEF DESCRIPTION OF THE DRAWINGS

FIG. 1 is a schematic flow chart of an image contrast enhancement method consistent with embodiments of the disclosure.

FIG. 2 is a schematic flow chart of another image contrast enhancement method consistent with embodiments of the disclosure.

FIG. 3 is a schematic diagram of an image contrast enhancement apparatus consistent with embodiments of the disclosure.

FIG. 4 is a schematic diagram of another image contrast enhancement apparatus consistent with embodiments of the disclosure.

FIG. 5 is a schematic diagram of an image contrast enhancement device consistent with embodiments of the disclosure.

### DETAILED DESCRIPTION OF THE EMBODIMENTS

Hereinafter, technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

When a digital photographing device is shooting, if an exposure range of its image sensor is lower than a dynamic range of a natural scene, an overexposure or underexposure of a captured image may be caused. Therefore, an image contrast of the captured image needs to be enhanced to improve detailed information in the image. In some application scenes of computer vision recognition, such as the face recognition, scene recognition, pedestrian detection, or the like, a more reliable input image can be provided to the computer visual recognition by enhancing the image contrast. An image contrast enhancement algorithm can be programmed in a chip of the photographing device to implement a real-time image contrast enhancement during shooting. In order to improve the effects of the image contrast enhancement, the present disclosure provides an image contrast enhancement method based on a pre-trained neural network.

A neural network can simulate the human brain neural network from a perspective of information processing, and establish a simplified model to form different networks according to different connection methods. The neural network refers to a computational model consisting of a large number of nodes (or neurons) connected to each other. Each node can represent a specific output function and can be referred to as an activation function. Outputs of different neural networks can be different according to a way the network is connected, and a weight value and the activation function of each node. A deep neural network (DNN) may include a convolutional neural network (CNN), a recurrent neural network (RNN), and the like. The DNN has the ability of adaptive, self-organizing, and real-time learning.

A training set of the neural network used herein can include a set of image pairs. Each image pair can include a first image and a second image for the same scene as a reference image. An image contrast of the first image can be lower than an image contrast of the second image. That is, the second image used for training the neural network can have a higher dynamic range and a higher image contrast compared to the first image, and thus, an end-to-end neural network with an ability to map an image having a low image contrast to an image having a high image contrast can be trained. Hereinafter, the embodiments consistent with the disclosure will be described with reference to the drawings.

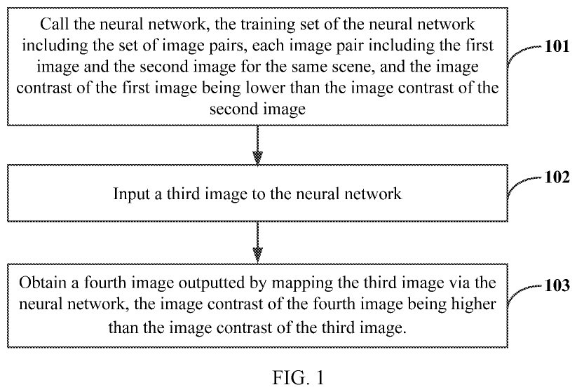

FIG. 1 is a schematic flow chart of an example image contrast enhancement method consistent with the disclosure. As shown in FIG. 1, at 101, the neural network is called. The training set of the neural network includes the set of image pairs, and each image pair includes the first image and the second image for the same scene. The image contrast of the first image is lower than the image contrast of the second image.

In some embodiments, the neural network may include a pre-trained neural network. In some embodiments, a device for pre-training the neural network may be different from a device for implementing the image contrast enhancement method. In some other embodiments, if the device for implementing the image contrast enhancement method has strong computational power, the neural network can be pre-trained by the same device, which is not limited herein.

The neural network can have the ability to map the images having the low image contrast to the images having the high image contrast. The training set can include the set of image pairs. The set of image pairs can include a plurality of image pairs. Each image pair can include the first image having the low image contrast and the second image having the high image contrast for the same scene. The second image can be generated using a multi-exposure image fusion algorithm to ensure that the dynamic range and the image contrast of the second image can be higher than those of the first image. As such, when the second image is inputted as the reference image to the neural network for learning, the neural network for enhancing the image contrast can be obtained.

The neural network can be regarded as an algorithm model, and when the image contrast needs to be enhanced, the neural network can be called by an execution entity of the algorithm model. In some embodiments, the algorithm model can be programmed in the chip of the photographing device in advance, such that the algorithm model can be called in real time to enhance the image contrast of the captured image during a shooting process of the photographing device. In some other embodiments, the algorithm model may be pre-stored in a memory of a computation device. When the computation device performs a batch image processing, the algorithm model can be called to perform a batch image contrast enhancement.

At 102, a third image is inputted to the neural network.

At 103, a fourth image outputted by mapping the third image via the neural network is obtained. The image contrast of the fourth image is higher than the image contrast of the third image.

Consistent with the disclosure, the image contrast enhancement method can use the pre-trained neural network. The training set of the neural network can include the set of image pairs. Each image pair can include the first image and the second image for the same scene, and the image contrast of the first image can be lower than that of the second image. Therefore, the neural network trained based on the training set described above can enhance the image contrast. During actual application, after the third image is inputted to the neural network, the third image having the low image contrast can be mapped to the fourth image having the high image contrast, thereby the enhancement of the image contrast of the third image can be achieved. As such, the fourth image having the high image quality can be obtained. Therefore, the method consistent with the disclosure can enhance any inputted image having the low image contrast to the high dynamic range of a multi-exposure fused image, and hence, the effect of a contrast-enhanced image can be more real and the image quality can be improved.

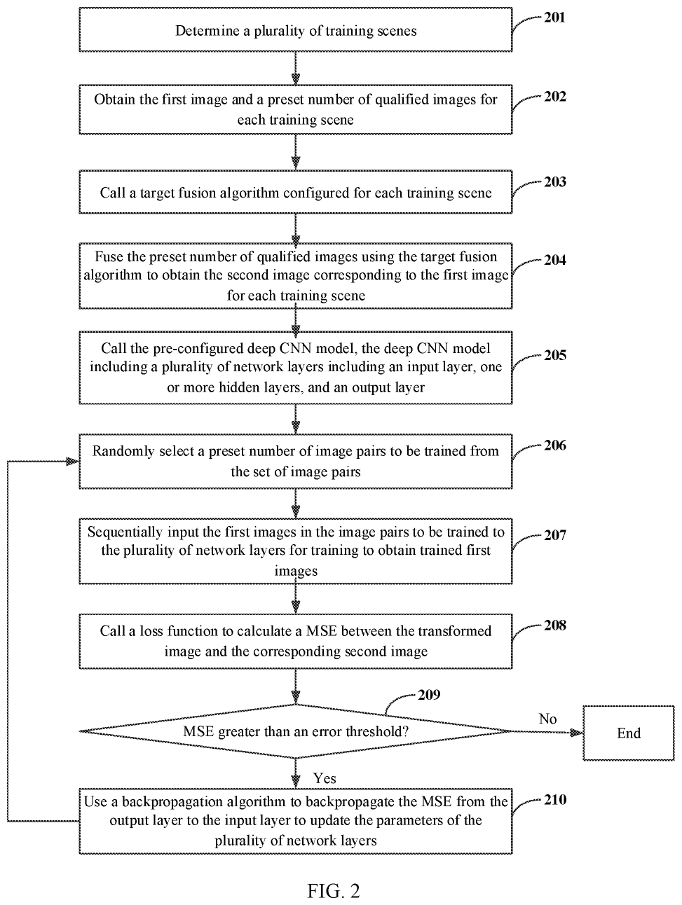

FIG. 2 is a schematic flow chart of another example image contrast enhancement method consistent with the disclosure. Taking the deep CNN as an example of the neural network, FIG. 2 shows a process of training the deep CNN for enhancing the image contrast. As shown in FIG. 2, at 201, a plurality of training scenes are determined.

Since there are many scenes in real world, in order to cause the deep CNN to have a universal applicability to different scenes, different types of training scenes may be determined before training. The number of scenes can be flexibly set as required, for example, more than 100 training scenes. The scenes may include scenes from real shot environments, and each scene may further include multiple sub-scenes. For example, the scenes may include forest scenes, river scenes, plant scenes, or the like, from the natural environment, and the plant scenes may further include the plant sub-scenes in different seasons. As another example, the scenes may include stair scenes, living room scenes, bedroom scenes, or the like, in an indoor environment, and the stair scenes may further include a straight ladder scene, a turn ladder scene, and the like.

At 202, the first image and a preset number of qualified images for each training scene are obtained. The first image captured for each of the plurality of training scenes determined at 201 can be obtained. Generally, the first image can have the low image contrast before being processed. A plurality of candidate images captured with different exposure parameters in the same training scene can be obtained. Although the plurality of candidate images are captured for the same scene, there are certain shooting time differences for them. When a moving object appears at a certain moment in the scene, a ghosting shadow can occur in the second image having the high image contrast and fused by the plurality of candidate images. Therefore, a screening condition can be set in advance, and the plurality of candidate images can be filtered by using the screening condition. The images including the moving object in the plurality of candidate images can be removed to obtain qualified images.

At 203, a target fusion algorithm configured for each training scene is called. In some embodiments, a preset number of fusion algorithms may be determined in advance, and the images for each training scene can be fused using each fusion algorithm to obtain a preset number of fused images. A fused image with the best image quality can be determined from the preset number of fused images, and the fusion algorithm for generating the fused image with the best image quality can be determined as the target fusion algorithm corresponding to the training scene. After the corresponding target fusion algorithm is determined for each training scene, the correspondence between the plurality of training scenes and the preset number of target fusion algorithms can be saved.

After the qualified images for each training scene are obtained at 202, when performing the image fusion for a certain target training scene, a scene name of the target training scene can be used as an index to query the pre-saved correspondence between the plurality of training scenes and the configured target fusion algorithms. After finding an algorithm name of the target fusion algorithm corresponding to the scene name, the target fusion algorithm can be called from the pre-saved fusion algorithms.

At 204, the preset number of qualified images are fused using the target fusion algorithm to obtain the second image corresponding to the first image for each training scene. After the target fusion algorithm corresponding to the target training scene is called, the target fusion algorithm can be used to fuse the qualified images for the target training scene. Because the fusion algorithm can select high-quality areas in each image and fuse these high-quality areas together, the qualified images with different exposure levels can be fused to obtain the second image in which the dynamic range is stretched and the image contrast is enhanced when compared to the first image.

After the fusion process is performed on the qualified images for all the training scenes, the set of image pairs can be obtained. Each image pair can include the first image and the second image for the same scene, and the image contrast of the first image can be lower than that of the second image.

At 205, the pre-configured deep CNN model is called. The deep CNN model can include a plurality of network layers including an input layer, one or more hidden layers, and an output layer. The deep CNN model can be trained in advance. The model can include the input layer, n hidden layers (also referred to as convolutional layers), and the output layer. Multiple filters can be provided for each layer. A size of each filter can be k×k, for example, 9×9, and each filter can be assigned an initial weight value.

At 206, a preset number of image pairs to be trained are randomly selected from the set of image pairs. When the deep CNN model is being trained, the preset number of image pairs may be randomly selected from the set of image pairs obtained at 204 as the image pairs to be trained. Assume that the first image in each image pair is denoted as x and the second image is denoted as y, the selected image pairs to be trained can be denoted as a set (x, y).

At 207, the first images in the image pairs to be trained are sequentially inputted to the plurality of network layers for training to obtain trained first images. The first image x of each image pair to be trained (x, y) may be inputted to the input layer of the plurality of network layers. Assume that there are N sets of image pairs to be trained, the first image x can be denoted as x⁽ⁱ⁾, and the second image y can be denoted as y⁽ⁱ⁾, where i is an integer equal to or larger than 1 and smaller than or equal to N.

At each of the plurality of network layers, the following processes can be implemented. A feature image is obtained by convoluting a predetermined number of filters W1 with the first image x⁽ⁱ⁾, i.e., W₁×x⁽ⁱ⁾. A preset nonlinear excitation function, for example, a rectified linear unit (ReLU) function, can be used to perform a nonlinear transform on the feature image to obtain a transformed image. The nonlinear transformation equation can be as follows:

F(x⁽ⁱ⁾,ω)=max [0,(Wₗ* x⁽ⁱ⁾+bᵢ)] Eq. 1

where F represents the ReLU function, ω represents a parameter of the network layer filter W, and bᵢ represents a constant.

The transformed image can be exported to a next network layer. After obtaining the transformed image outputted by the output layer in the plurality of network layers, the first image trained by the deep CNN can be obtained. After obtaining the transformed images outputted by the output layer in the plurality of network layers for the first images in all the image pairs to be trained, a set of trained first images trained by the deep CNN can be obtained.

At 208, a loss function is called to calculate a mean square error (MSE) between the trained first image and the corresponding second image. The MSE between the transformed image and the second image y⁽ⁱ⁾ as the reference image can be calculated using the loss function as follows:

$$L = \frac{1}{N} {\sum }_{i}^{N} ‖ {y}^{( i )} - F ( {x}^{( i )} , ω ) ‖ \qquad Eq . 2$$

At 209, whether the MSE is greater than an error threshold is determined, and if yes, the process at 210 is performed, otherwise, the current flow is ended.

A smaller MSE L may indicate that the transformed image F(x⁽ⁱ⁾,ω) is closer to the second image y⁽ⁱ⁾. When the MSE L is as small as a certain value, it can indicate that the training of the deep CNN is completed. In some embodiments, the error threshold can be set in advance, and the error threshold can be used to determine whether the loss function converges. If a determination result is that the MSE L is greater than the error threshold, it indicates that the loss function has not converged yet, and the process at 210 needs to be continued. If the determination result is that the MSE L is less than or equal to the error threshold, it indicates that the loss function has converged. Therefore, the parameters of each network layer at this moment (including the weight values of the filters) can be saved, and the training of the deep CNN is completed.

At 210, a backpropagation algorithm is used to backpropagate the MSE from the output layer to the input layer to update the parameters of the plurality of network layers, and the implementation flow returns to the process at 206. Since the loss function has not yet converged, the backpropagation algorithm can be used in a reverse direction from the output layer to the input layer to calculate a partial derivative of the MSE to the weight value of each filter for each network layer using the following formula Eq. 3, and a partial derivative of the MSE to x of each network layer using the following formula Eq. 4.

$$\begin{matrix}\frac{d [ {y}^{( i )} , F ( {x}^{( i )} , ω ) ]}{d ω} & Eq . 3 \\ \frac{d [ {y}^{( i )} , F ( {x}^{( i )} , ω ) ]}{dx} & Eq . 4\end{matrix}$$

For each network layer, the update weight values of the filters can be obtained by calculating differences between the original weight values of the filters and the corresponding partial derivative values. The weight values of the filters can be updated with the corresponding updated weight values, and the original x can be updated by the partial derivative of x, and then the implementation flow can return to the process at 206.

Consistent with the disclosure, the image contrast enhancement method can use the pre-trained neural network. The training set of the neural network can include the set of image pairs. Each image pair can include the first image and the second image for the same scene, and the image contrast of the first image can be lower than that of the second image. Therefore, the neural network trained based on the training set described above can enhance the image contrast. After the third image is inputted to the neural network, the third image having the low image contrast can be mapped to the fourth image having the high image contrast, thereby the enhancement of the image contrast of the third image can be achieved. As such, the fourth image having the high image quality can be obtained. Therefore, the method consistent with the disclosure can enhance any inputted image having the low image contrast to the high dynamic range of a multi-exposure fused image, and hence, the effect of the contrast-enhanced image can be more real and the image quality can be improved.

Corresponding to the image contrast enhancement methods described above, the present disclosure also provides an image contrast enhancement apparatus, device, and storage medium.

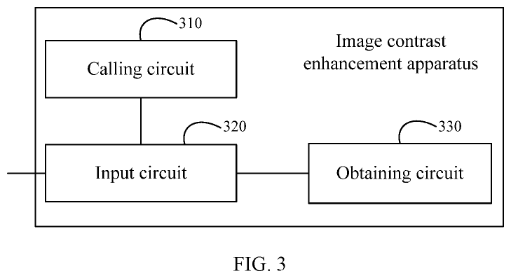

FIG. 3 is a schematic diagram of an example image contrast enhancement apparatus consistent with the disclosure. As shown in FIG. 3, the apparatus includes a calling circuit 310, an input circuit 320, and an obtaining circuit 330.

The calling circuit 310 can be configured to call the neural network. The training set of the neural network can include the set of image pairs, and each image pair can include the first image and the second image for the same scene. The image contrast of the first image can be lower than that of the second image.

The input circuit 320 can be configured to input the third image to the neural network.

The obtaining circuit 330 can be configured to obtain the fourth image outputted by mapping the third image to the fourth image via the neural network. The image contrast of the fourth image can be higher than that of the third image.

FIG. 4 is a schematic diagram of another example image contrast enhancement apparatus consistent with the disclosure. The apparatus shown in FIG. 4 is similar to the apparatus shown in FIG. 3, except that the apparatus shown in FIG. 4 further includes a generation circuit 340 and a training circuit 350.

The generation circuit 340 can be configured to generate the set of image pairs using the multi-exposure image fusion algorithm.

The training circuit 350 can be configured to train the neural network using the set of image pairs as the training set.

In some embodiments, the generation circuit 340 can include a scene determination sub-circuit, an image acquisition sub-circuit, an algorithm calling sub-circuit, and an image fusion sub-circuit (not shown in FIG. 4). The scene determination sub-circuit can be configured to determine the plurality of training scenes. The image acquisition sub-circuit can be configured to obtain the first image and the preset number of qualified images for each training scene. The algorithm calling sub-circuit can be configured to call the target fusion algorithm configured for each training scene. The image fusion sub-circuit can be configured to fuse the preset number of qualified images using the target fusion algorithm to obtain the second image corresponding to the first image for each training scene.

In some embodiments, the image acquisition sub-circuit can be further configured to capture the first image shot in each of the plurality of training scenes and the plurality of candidate images shot with different exposure parameters, and obtain the qualified images satisfying a preset condition that are selected from the plurality of candidate images. The preset condition can include that the selected qualified images do not include any moving object.

In some embodiments, the algorithm calling sub-circuit can be further configured to use the scene name of the target training scene as the index to query the pre-saved correspondence between the plurality of training scenes and the configured target fusion algorithms, and call the target fusion algorithm from the pre-saved fusion algorithms according to the algorithm name of the target fusion algorithm corresponding to the scene name.

In some embodiments, the training circuit 350 can include a model calling sub-circuit, an iterative processing sub-circuit, an image extraction sub-circuit, an image training sub-circuit, an error calculation sub-circuit, and a backpropagation sub-circuit. The model calling sub-circuit can be configured to call the pre-configured deep CNN model. The deep CNN model can include the plurality of network layers including the input layer, the one or more hidden layers, and the output layer. The iterative processing sub-circuit can be configured to repeatedly trigger the image extraction sub-circuit, the image training sub-circuit, the error calculation sub-circuit, and the backpropagation sub-circuit to perform the training processes until the loss function converges. The image extraction sub-circuit can be configured to randomly select the preset number of image pairs to be trained from the set of image pairs. The image training sub-circuit can be configured to sequentially input the first images in the image pairs to be trained to the plurality of network layers for training to obtain the trained first images. The error calculation sub-circuit can be configured to call the loss function to calculate the MSE between the trained first image and the corresponding second image. The backpropagation sub-circuit can be configured, if the MSE is determined to be greater than the error threshold, to backpropagate the MSE from the output layer to the input layer using the backpropagation algorithm to update the parameters of the plurality of network layers.

In some embodiments, the image training sub-circuit can be further configured to input the first image of each image pair to be trained to the input layer of the plurality of network layers. The image training sub-circuit can be further configured to, at each network layer, convolve the predetermined number of filters with the first image to obtain the feature image, perform the non-linear transformation on the feature image to obtain the transformed image, and output the transformed image to the next network layer. The image training sub-circuit can be further configured to obtain the transformed image outputted by the output layer of the plurality of network layers to obtain the trained first image.

In some embodiments, the backpropagation sub-circuit can be further configured to calculate the partial derivative of the MSE for each filter of each network layer in the reverse direction from the output layer to the input layer, obtain the update weight value of the filter according to the difference between the original weight value of the filter and the corresponding partial derivative value, and update the weight value of the filter with the update weight value.

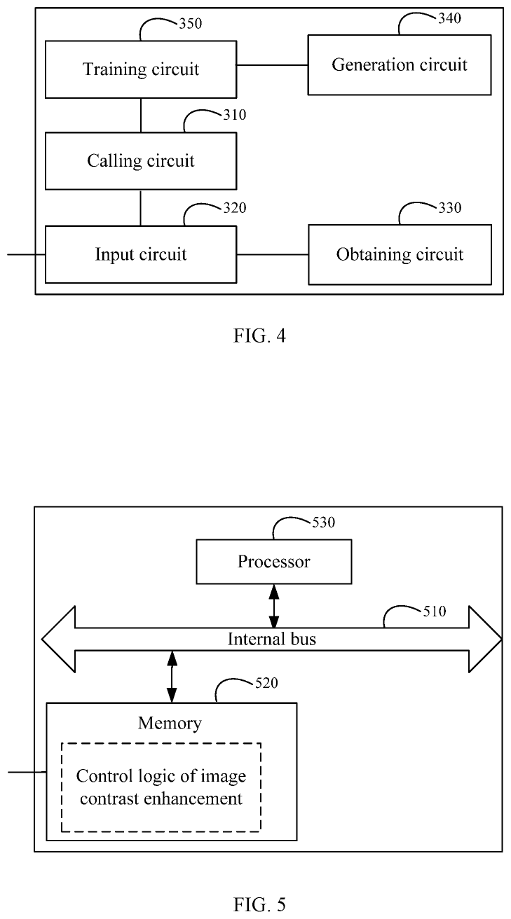

FIG. 5 is a schematic diagram of an example image contrast enhancement device consistent with the disclosure. As shown in FIG. 5, the device includes a memory 520 and a processor 530 connected to each other by an internal bus 510. The memory 520 can be configured to store computer readable instructions corresponding to a control logic of image contrast enhancement. The processor 530 can be configured to read the computer readable instructions stored on the memory 520 and execute the instructions to implement the following processes.

The neural network is called. The training set of the neural network can include the set of image pairs, and each image pair can include the first image and the second image for the same scene. The image contrast of the first image can be lower than that of the second image. The third image is inputted to the neural network. The fourth image outputted by mapping the third image to the fourth image via the neural network is obtained. The image contrast of the fourth image can be higher than that of the third image.

In some embodiments, the processor 530 can be further configured to generate the set of image pairs using the multi-exposure image fusion algorithm and train the neural network using the set of image pairs as the training set.

In some embodiments, when generating the set of image pairs using the multi-exposure image fusion algorithm, the processor 530 can be further configured to determine the plurality of training scenes, obtain the first image and the preset number of qualified images for each training scene, call the target fusion algorithm configured for each training scene, and fuse the preset number of qualified images using the target fusion algorithm to obtain the second image corresponding to the first image for each training scene.

In some embodiments, when obtaining the first image and the preset number of qualified images for each training scene, the processor 530 can be further configured to capture the first image shot in each of the plurality of training scenes and the plurality of candidate images shot with different exposure parameters, and obtain the qualified images satisfying the preset condition that are selected from the plurality of candidate images. The preset condition can include that the selected qualified images do not include any moving object.

In some embodiments, when calling the target fusion algorithm configured for each training scene, the processor 530 can be further configured to use the scene name of the target training scene as the index to query the pre-saved correspondence between the plurality of training scenes and the configured target fusion algorithms, and call the target fusion algorithm from the pre-saved fusion algorithms according to the algorithm name of the target fusion algorithm corresponding to the scene name.

In some embodiments, when training the neural network using the set of image pairs as the training set, the processor 530 can be further configured to call the pre-configured deep CNN model. The deep CNN model can include the plurality of network layers including the input layer, the one or more hidden layers, and the output layer. The processor 530 can be further configured to repeatedly implement the following training processes until the loss function converges.

The preset number of image pairs to be trained are randomly selected from the set of image pairs. The first images in the image pairs to be trained are sequentially inputted to the plurality of network layers for training to obtain the trained first images. The loss function is called to calculate the MSE between the trained first image and the corresponding second image. If the MSE is determined to be greater than the error threshold, the MSE is backpropagated from the output layer to the input layer using the backpropagation algorithm to update the parameters of the plurality of network layers.

In some embodiments, when sequentially inputting the first images in the image pairs to be trained to the plurality of network layers for training to obtain the trained first images, the processor 530 can be further configured to input the first image of each image pair to be trained to the input layer of the plurality of network layers, at each network layer, convolve the predetermined number of filters with the first image to obtain the feature image, perform the non-linear transformation on the feature image to obtain the transformed image, and output the transformed image to the next network layer, and obtain the transformed image outputted by the output layer of the plurality of network layers to obtain the trained first image.

In some embodiments, when backpropagating the MSE from the output layer to the input layer using the backpropagation algorithm to update the parameters of the plurality of network layers, the processor 530 can be further configured to calculate the partial derivative of the MSE for each filter of each network layer in the reverse direction from the output layer to the input layer, obtain the update weight value of the filter according to the difference between the original weight value of the filter and the corresponding partial derivative value, and update the weight value of the filter with the update weight value.

In some embodiments, the device may include an unmanned aerial vehicle (UAV), a handheld camera device, a terminal device, or the like.

The present disclosure also provides a computer readable storage medium storing a plurality of computer instructions. When the computer instructions are being executed, the following processes are implemented.

The neural network is called. The training set of the neural network can include the set of image pairs, and each image pair can include the first image and the second image for the same scene. The image contrast of the first image can be lower than that of the second image. The third image is inputted to the neural network. The fourth image outputted by mapping the third image to the fourth image via the neural network is obtained. The image contrast of the fourth image can be higher than that of the third image.

In some embodiments, when the computer instructions are being executed, the following processes are further implemented. The set of image pairs is generated using the multi-exposure image fusion algorithm and the neural network is trained using the set of image pairs as the training set.

In some embodiments, when the computer instructions are being executed to generate the set of image pairs using the multi-exposure image fusion algorithm, the following processes are implemented. The plurality of training scenes is determined. The first image and the preset number of qualified images for each training scene are obtained. The target fusion algorithm configured for each training scene is called. The preset number of qualified images are fused using the target fusion algorithm to obtain the second image corresponding to the first image for each training scene.

In some embodiments, when the computer instructions are being executed to obtain the first image and the preset number of qualified images for each training scene, the following processes are implemented. The first image shot in each of the plurality of training scenes and the plurality of candidate images shot with different exposure parameters are captured. The qualified images satisfying the preset condition that are selected from the plurality of candidate images are obtained. The preset condition can include that the selected qualified images do not include any moving object.

In some embodiments, when the computer instructions are being executed to call the target fusion algorithm configured for each training scene, the following processes are implemented. The scene name of the target training scene is used as the index to query the pre-saved correspondence between the plurality of training scenes and the configured target fusion algorithms, and the target fusion algorithm is called from the pre-saved fusion algorithms according to the algorithm name of the target fusion algorithm corresponding to the scene name.

In some embodiments, when the computer instructions are being executed to train the neural network using the set of image pairs as the training set, the following processes are implemented. The pre-configured deep CNN model is called. The deep CNN model can include the plurality of network layers including the input layer, the one or more hidden layers, and the output layer. The following training processes are repeatedly implemented until the loss function converges.

The preset number of image pairs to be trained are randomly selected from the set of image pairs. The first images in the image pairs to be trained are sequentially inputted to the plurality of network layers for training to obtain the trained first images. The loss function is called to calculate the MSE between the trained first image and the corresponding second image. If the MSE is determined to be greater than the error threshold, the MSE is backpropagated from the output layer to the input layer using the backpropagation algorithm to update the parameters of the plurality of network layers.

In some embodiments, when the computer instructions are being executed to sequentially input the first images in the image pairs to be trained to the plurality of network layers for training to obtain the trained first images, the following processes are implemented. The first image of each image pair to be trained is inputted to the input layer of the plurality of network layers. At each network layer, the predetermined number of filters are convolved with the first image to obtain the feature image, the non-linear transformation is performed on the feature image to obtain the transformed image, and the transformed image is outputted to the next network layer. The transformed image outputted by the output layer of the plurality of network layers is obtained to obtain the trained first image.

In some embodiments, when the computer instructions are being executed to backpropagate the MSE from the output layer to the input layer using the backpropagation algorithm to update the parameters of the plurality of network layers, the following processes are implemented. The partial derivative of the MSE for each filter of each network layer in the reverse direction from the output layer to the input layer is calculated. The update weight value of the filter is obtained according to the difference between the original weight value of the filter and the corresponding partial derivative value, and the weight value of the filter is updated with the update weight value.

Detailed descriptions of the example apparatus may be omitted and references can be made to the descriptions of the example methods. The apparatus described above are merely illustrative. The circuits/units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. Those of ordinary skill in the art can understand and implement the present disclosure without any creative effort.

The terms “first,” “second,” or the like in the specification, claims, and the drawings of the present disclosure are merely used to distinguish similar elements, and are not intended to describe a specified order or a sequence. In addition, the terms “including,” “comprising,” and variations thereof herein are open, non-limiting terminologies, which are meant to encompass a series of steps of processes and methods, or a series of units of systems, apparatuses, or devices listed thereafter and equivalents thereof as well as additional steps of the processes and methods or units of the systems, apparatuses, or devices.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. An image contrast enhancement method comprising:
calling a neural network trained using a set of image pairs each including a first image and a second image for a same scene, an image contrast of the first image being lower than an image contrast of the second image;
inputting a third image to the neural network; and
obtaining a fourth image outputted by mapping the third image via the neural network, an image contrast of the fourth image being higher than an image contrast of the third image.

2. The method of claim 1, further comprising:
generating the set of image pairs using a multi-exposure image fusion algorithm; and
training the neural network using the set of image pairs.

3. The method of claim 2, wherein generating the set of image pairs using the multi-exposure image fusion algorithm includes:
determining a plurality of training scenes; and
for one training scene of the plurality of training scenes:
obtaining the first image and a preset number of qualified images for the one training scene;
calling a target fusion algorithm configured for the one training scene; and
fusing the preset number of qualified images using the target fusion algorithm to obtain the second image corresponding to the first image for the one training scene.

4. The method of claim 3, wherein obtaining the first image and the preset number of qualified images for the one training scene includes:
capturing the first image shot in the one training scene and a plurality of candidate images shot with different exposure parameters; and
selecting those of the plurality of candidate images that do not include any moving object as the qualified images.

5. The method of claim 3, wherein calling the target fusion algorithm configured for the one training scene includes:
using a scene name of the one training scene as an index to query a pre-saved correspondence between training scenes and fusion algorithms; and
calling the target fusion algorithm from pre-saved fusion algorithms according to an algorithm name of the target fusion algorithm corresponding to the scene name.

6. The method of claim 2, wherein training the neural network using the set of image pairs includes:
calling a pre-configured deep convolutional neural network (CNN) model, the deep CNN model including a plurality of network layers that include an input layer, one or more hidden layers, and an output layer; and
repeating the following training processes until a loss function converges:
randomly selecting a preset number of image pairs to be trained from the set of image pairs;
sequentially inputting the first images of the image pairs to be trained to the plurality of network layers for training to obtain trained first images;
calling the loss function to calculate a mean square error (MSE) between the trained first images and the corresponding second images; and
backpropagating, in response to the MSE being determined to be greater than an error threshold, the MSE from the output layer to the input layer using a backpropagation algorithm to update parameters of the plurality of network layers.

7. The method of claim 6, wherein sequentially inputting the first images of the image pairs to be trained to the plurality of network layers for training to obtain the trained first images includes:
inputting the first image of each of the image pairs to be trained to the input layer of the plurality of network layers;
at each of the network layers:
convolving a predetermined number of filters with the first image to obtain a feature image;
performing a non-linear transformation on the feature image to obtain a transformed image; and
outputting the transformed image to a next network layer; and
obtaining the transformed images outputted by the output layer as the trained first images.

8. The method of claim 7, wherein backpropagating the MSE from the output layer to the input layer includes:
calculating a partial derivative of the MSE for each filter of each of the network layers in a reverse direction from the output layer to the input layer;
obtaining an updated weight value of the filter according to a difference between an original weight value of the filter and the corresponding partial derivative value; and
updating a weight value of the filter with the update weight value.

9. An image contrast enhancement apparatus comprising:
a processor; and
a memory coupled to the processor and storing computer readable instructions that, when executed by the processor, cause the processor to:
call a neural network trained using a set of image pairs each including a first image and a second image for a same scene, an image contrast of the first image being higher than an image contrast of the second image;
input a third image to the neural network; and
obtain a fourth image outputted by mapping the third image via the neural network, an image contrast of the fourth image being higher than an image contrast of the third image.

10. The apparatus of claim 9, wherein the instructions further cause the processor to:
generate the set of image pairs using a multi-exposure image fusion algorithm; and
train the neural network using the set of image pairs.

11. The apparatus of claim 10, wherein the instructions further cause the processor to:
determine a plurality of training scenes; and
for one training scene of the plurality of training scenes:
obtain the first image and a preset number of qualified images for the one training scene;
call a target fusion algorithm configured for the one training scene; and
fuse the preset number of qualified images using the target fusion algorithm to obtain the second image corresponding to the first image for the one training scene.

12. The apparatus of claim 11, wherein the instructions further cause the processor to:
capture the first image shot in the one training scene and a plurality of candidate images shot with different exposure parameters; and
select those of the plurality of candidate images that do not include any moving object as the qualified images.

13. The apparatus of claim 11, wherein the instructions further cause the processor to:
use a scene name of the one training scene as an index to query a pre-saved correspondence between training scenes and fusion algorithms; and
call the target fusion algorithm from pre-saved fusion algorithms according to an algorithm name of the target fusion algorithm corresponding to the scene name.

14. The apparatus of claim 10, wherein the instructions further cause the processor to:
call a pre-configured deep convolutional neural network (CNN) model, the deep CNN model including a plurality of network layers that include an input layer, one or more hidden layers, and an output layer; and
repeat the following training processes until a loss function converges:
randomly select a preset number of image pairs to be trained from the set of image pairs;
sequentially input the first images of the image pairs to be trained to the plurality of network layers for training to obtain trained first images;
call the loss function to calculate a mean square error (MSE) between the trained first images and the corresponding second images; and
backpropagate, in response to the MSE being determined to be greater than an error threshold, the MSE from the output layer to the input layer using a backpropagation algorithm to update parameters of the plurality of network layers.

15. The apparatus of claim 14, wherein the instructions further cause the processor to:
input the first image of each of the image pairs to be trained to the input layer of the plurality of network layers;
at each of the network layers:
convolve a predetermined number of filters with the first image to obtain a feature image;
perform a non-linear transformation on the feature image to obtain a transformed image; and
output the transformed image to a next network layer; and
obtain the transformed images outputted by the output layer as the trained first images.

16. The apparatus of claim 15, wherein the instructions further cause the processor to:
calculate a partial derivative of the MSE for each filter of each of the network layers in a reverse direction from the output layer to the input layer;
obtain an updated weight value of the filter according to a difference between an original weight value of the filter and the corresponding partial derivative value; and
update a weight value of the filter with the update weight value.

17. The apparatus of claim 9, wherein the apparatus includes at least one of an unmanned aerial vehicle (UAV), a handheld camera device, or a terminal device.

18. A model training method comprising:
generating a set of image pairs using a multi-exposure image fusion algorithm, each image pair of the set of image pairs including a first image and a second image for a same scene, and an image contrast of the first image being lower than an image contrast of the second image; and
training a neural network using the set of image pairs.

19. The method of claim 18, wherein generating the set of image pairs using the multi-exposure image fusion algorithm includes:
determining a plurality of training scenes; and
for one training scene of the plurality of training scenes:
obtaining the first image and a preset number of qualified images for the one training scene;
calling a target fusion algorithm configured for the one training scene; and
fusing the preset number of qualified images using the target fusion algorithm to obtain the second image corresponding to the first image for the one training scene.

20. The method of claim 18, wherein training the neural network using the set of image pairs includes:
calling a pre-configured deep convolutional neural network (CNN) model, the deep CNN model including a plurality of network layers that include an input layer, one or more hidden layers, and an output layer; and
repeating the following training processes until a loss function converges:
randomly selecting a preset number of image pairs to be trained from the set of image pairs;
sequentially inputting the first images of the image pairs to be trained to the plurality of network layers for training to obtain trained first images;
calling the loss function to calculate a mean square error (MSE) between the trained first images and the corresponding second images; and
backpropagating, in response to the MSE being determined to be greater than an error threshold, the MSE from the output layer to the input layer using a backpropagation algorithm to update parameters of the plurality of network layers.
